(19) United States
(12) Patent Application Publication
(10) Pub. No.: US 2003/0169818 A1
(43) Pub. Date: Sep. 11, 2003

(54) Video transcoder based joint video and still image pipeline with still burst mode

(76) Inventor: Pere Obrador, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/090,778

(22) Filed: Mar. 6, 2002

(51) Int. Cl. H04N 7/12

(52) U.S. Cl. 375/240.21; 375/240.24

(57) ABSTRACT

A digital video camera system may utilize a joint video and still image pipeline that simultaneously acquires, processes, transmits and/or stores digital video and high resolution digital still image photographs. The joint pipeline may include a video pipeline optimized for digital video frames and a high resolution still image pipeline optimized for high resolution digital still image frames. The digital video camera system may also concurrently acquire and process video frames and high resolution still image frames in burst mode by downsampling the video frames into reduced size video frames so that the single processing pipeline can allot more time to process the high resolution still image frames in real time. The loss in video quality may be compensated using motion estimation and information from the high resolution still image frames.

### TECHNICAL FIELD

The technical field relates to video imaging systems, and, in particular, to joint video and still image pipelines.

### BACKGROUND

Digital cameras are widely used to acquire high resolution still image photographs. Digital video cameras are also used to record home videos, television programs, movies, concerts, or sports events on a magnetic disk or optical DVD for storage or transmission through communications channels. Some commercial cameras are able to take both digital video and digital still image photographs. However, most of these cameras required a user to switch between a video recording mode and a digital still image mode. Separate pipelines are generally used for each of the video recording and still image modes. Examples of these cameras include SANYO ID-SHOT® and CANNON POWERSHOT S300®. The SANYO ID-SHOT® uses an optical disk, whereas the CANNON POWERSHOT S300® uses synchronous dynamic random access memory (SDRAM). However, both cameras are still image cameras that have the capability of taking video clips, using separate pipelines.

Other cameras use a single software pipeline to acquire both digital video and low quality still images by taking one of the video frames as is, and storing the particular video frame as a high resolution still image. Examples of such cameras include JVC GR-DVL9800®, which is a digital video camera that allows a user to take a picture at certain point in time. However, the pictures taken generally are of low quality, because a low resolution video pipeline is used to generate the high resolution still image pictures.

When still images are acquired in burst mode, current cameras try to process both pipelines independently. If a single hardware processing pipeline is used, a large frame buffer may be needed to store video frames while the burst mode still images are processed. However, a large frame buffer is costly, and build up delay on the video side may be undesirable.

### SUMMARY

A method and corresponding apparatus for concurrently processing digital video frames and high resolution still images in burst mode includes acquiring regular size video frames and high resolution still image frames in burst mode from one or more image sensors, and downsampling the regular size video frames into reduced size video frames in real time so that the reduced size video frames have frame sizes smaller than the regular size video frames. The method further includes processing the high resolution still image frames acquired during the burst mode using a high resolution still image pipeline, and processing the reduced size frames using a video pipeline. The high resolution still image frames are processed concurrently with the reduced size video frames.

In an embodiment of the method, the reduced size video frames are upsampled using motion estimation and information from the high resolution still image frames. In another embodiment of the method, the high resolution still image frames are downsampled into downsampled still image frames that have the same frame size as the upsampled video frames. Blocks in the downsampled still image frames form a block pool. In yet another embodiment, blocks in the block pool are compared with corresponding blocks in the upsampled video frames until a best match block is found. The best match block is then copied into the corresponding blocks in the upsampled video frames to compensate the loss in video quality.

### DESCRIPTION OF THE DRAWINGS

The preferred embodiments of the method and apparatus for concurrently processing digital video frames and high resolution still images in burst mode will be described in detail with reference to the following figures, in which like numerals refer to like elements, and wherein:

FIG. 1 illustrates an exemplary operation of an exemplary joint video and still image pipeline;

FIG. 2 illustrates a preferred embodiment of a video camera system using the exemplary joint video and still image pipeline of FIG. 1;

FIG. 3 illustrates an exemplary hardware implementation of the exemplary joint video and still image pipeline of FIG. 1;

FIGS. 4A-4C are flow charts describing in general the exemplary joint video and still image pipeline of FIG. 1;

FIGS. 5A-5E illustrate an exemplary motion estimation technology used by the video camera system of FIG. 2;

FIG. 6 is a flow chart illustrating an exemplary method for concurrently processing digital video frames and high resolution still images in burst mode; and

FIG. 7 is a flow chart illustrating the exemplary motion estimation technology shown in FIGS. 5A-5E.

### DETAILED DESCRIPTION

A digital video camera system may utilize a joint video and still image pipeline that simultaneously acquires, processes, transmits and/or stores digital video and high resolution digital still image photographs. The joint pipeline may include a video pipeline optimized for digital video frames and a high resolution still image pipeline optimized for high resolution digital still images. The digital video camera system may also concurrently acquire and process video frames and high resolution still image in burst mode by downsampling the video frames into reduced size video frames so that the single processing pipeline can allot more time to process the high resolution still images in real time. The loss in video quality may be compensated using motion estimation and information from the high resolution still images.

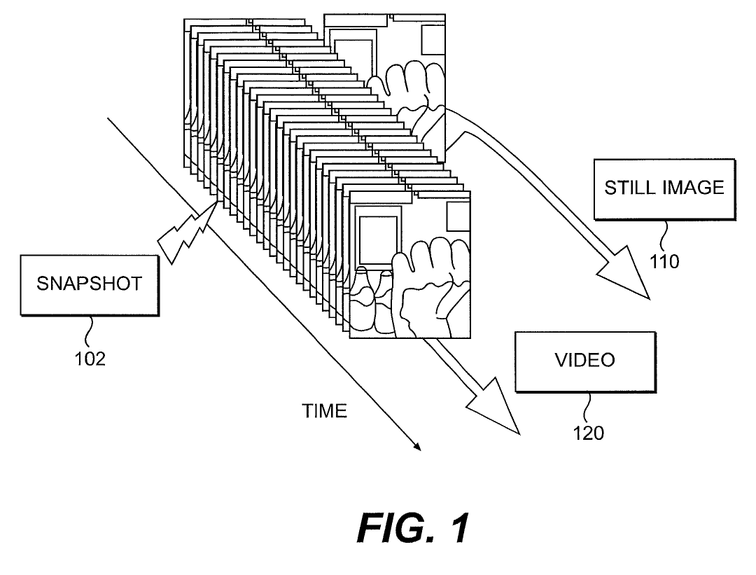

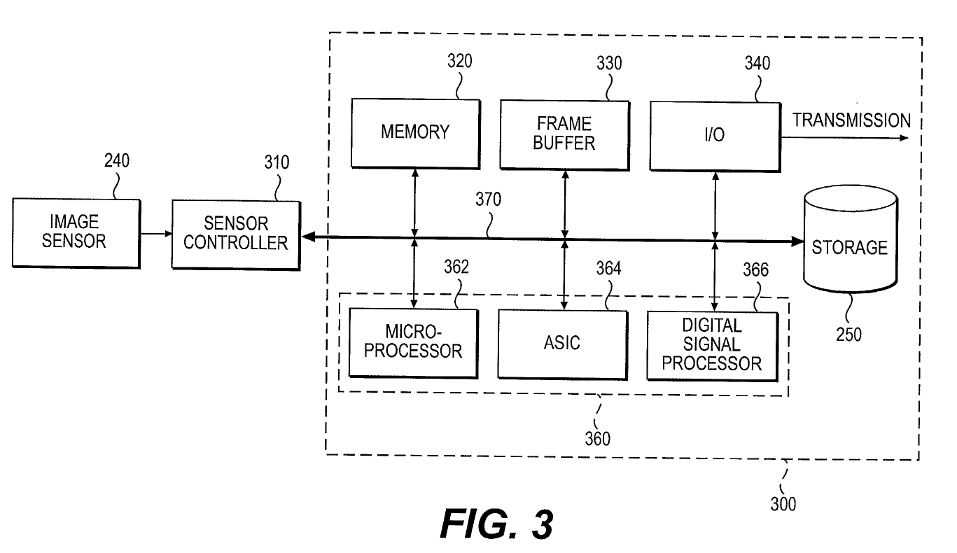

FIG. 1 illustrates an exemplary operation of an exemplary joint video and still image pipeline, which is capable of simultaneously capturing digital video frames 120 and high resolution digital still image frames 110. The video frames 120 may be acquired at, for example, 30 frames per second (fps). During video frame acquisition, a snapshot 102 may be taken to acquire a particular still image frame 110 in high resolution, which is then processed. During the high resolution still image processing, all incoming video frames 120 that are captured during that time may be temporarily stored, i.e., buffered, in a frame buffer 330 (shown in FIG. 3) before being processed. Both the video frames 120 and the high resolution still image frame 110 may be stored or transmitted through communications channels, such as a network.

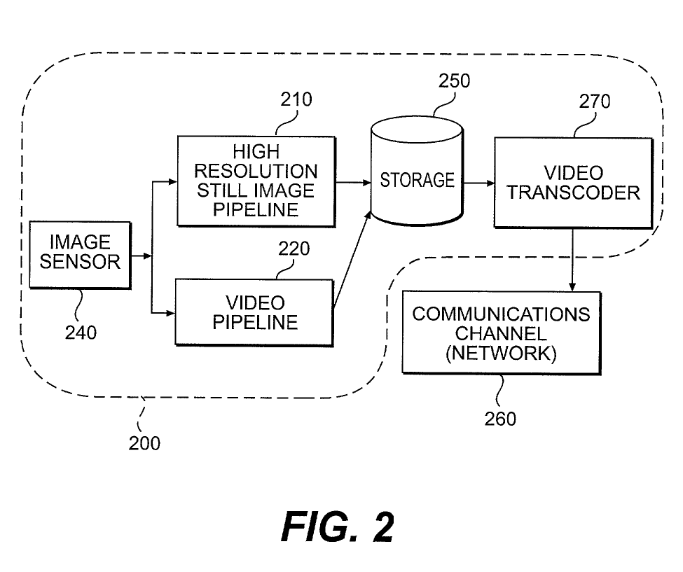

FIG. 2 illustrates a preferred embodiment of a video camera system 200 using the exemplary joint video and still image pipeline. In this embodiment, a video pipeline 220 and a high resolution still image pipeline 210 share a same high resolution image sensor 240. The high resolution image sensor 240, which may be a charge coupled device (CCD) sensor or a complimentary metal oxide semiconductor (CMOS) sensor, may take high resolution still image frames 110 while acquiring medium resolution video frames 120. This embodiment is inexpensive because the video camera system 200 uses one hardware processing pipeline 300 (shown in FIG. 3) with one image sensor 240 and one processor 360 (shown in FIG. 3).

The image sensor 240 typically continuously acquires high resolution video frames 120 at a rate of, for example, 30 fps. Each of the high resolution video frames 120 may be converted into a high resolution still image photograph 110. When a user is not interested in taking a high resolution still image photograph 110, the only pipeline running may be the video pipeline 220, which acquires high resolution video frames 120, and downsamples the frames to medium resolution (for example, 640×480), then processes the medium resolution video frames 120. When the user wants to acquire a high resolution still image frame 110, the image acquired by the high resolution image sensor 240 can be used both in the video pipeline 220 as well as in the high resolution still image pipeline 210 (described in detail later).

The video camera system 200 may include a storage device 250 and a connection with a communications channel/network 260, such as the Internet or other type of computer or telephone networks. The storage device 250 may include a hard disk drive, floppy disk drive, CD-ROM drive, or other types of non-volatile data storage, and may correspond with various databases or other resources. After the video frames 120 and the high resolution still image frames 110 are acquired, the video frames 120 and the high resolution still image frames 110 may be stored in the storage device 250 or transmitted through the communication channel 260. The video camera system 200 may also include a video transcoding agent 270 for encoding the video frames 120 into a standard format, for example, motion picture expert group-2 (MPEG-2).

FIG. 3 illustrates an exemplary hardware implementation of the preferred embodiment of the exemplary joint video and still image pipeline. This embodiment includes the single hardware processing pipeline 300 supporting two software pipelines. A sensor controller 310 may be controlled by a user to retrieve high resolution mosaiced still image frames 110 at a rate of, for example, one every thirtieth of a second to generate a video signal. The sensor controller 310 may then store the selected high resolution still image frames 110 into a memory 320. The memory 320 may include random access memory (RAM) or similar types of memory. Next, the high resolution still image frames 110 may be processed using the processor 360, which may be a microprocessor 362, an ASIC 364, or a digital signal processor 366. The ASIC 362 performs algorithms quickly, but is typically application specific and only performs a specific algorithm. On the other hand, the microprocessor 362 or the digital signal processor 366 may perform many other tasks. The processor 360 may execute information stored in the memory 320 or the storage device 250, or information received from the Internet or other network 260. The digital video and still image data may be copied to various components of the pipeline 300 over a data bus 370.

In the video pipeline 220, the processor 360 may downsample, demosaic, and color correct the video frames 120. Next, the processor 360 may compress and transmit the video frames 120 through an input/output (I/O) unit 340. Alternatively, the video frames 120 may be stored in the storage device 250.

Both pipelines may be executed concurrently, i.e., acquiring high resolution still image photographs 110 during video recording. A frame buffer 330 may store video frames 120 while the processor 360 is processing the high resolution still image frame 110. The sensor controller 310 may still capture video frames 120 at a rate of, for example, 30 fps, and store the video frames 120 into the memory 320. The processor 360 may downsample the video frames 120 and send the downsampled video frames 120 into the frame buffer 330. The frame buffer 330 may store the downsampled video frames 120 temporarily without further processing. This may incur some delay in the video pipeline 220 if the video is directly transmitted through the communications channel 260. However, this delay may be compensated by a similar buffer on the receiver end. During video frame buffering, the high resolution still image frame 110 may be processed by the processor 360, using complex algorithms. At the same time, the video frames 120 are continuously stored into the memory 320, downsampled, and sent into the frame buffer 330 to be stored. Minimal video buffering is preferred and may be achieved through real time video downsampling (described in detail later).

Although the video camera system 200 is shown with various components, one skilled in the art will appreciate that the video camera system 200 can contain additional or different components. In addition, although the video frames 120 and the still image frames 110 are described as being stored in memory, one skilled in the art will appreciate that the video frames 120 and the still image frames 110 can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the video camera system 200 to perform a particular method.

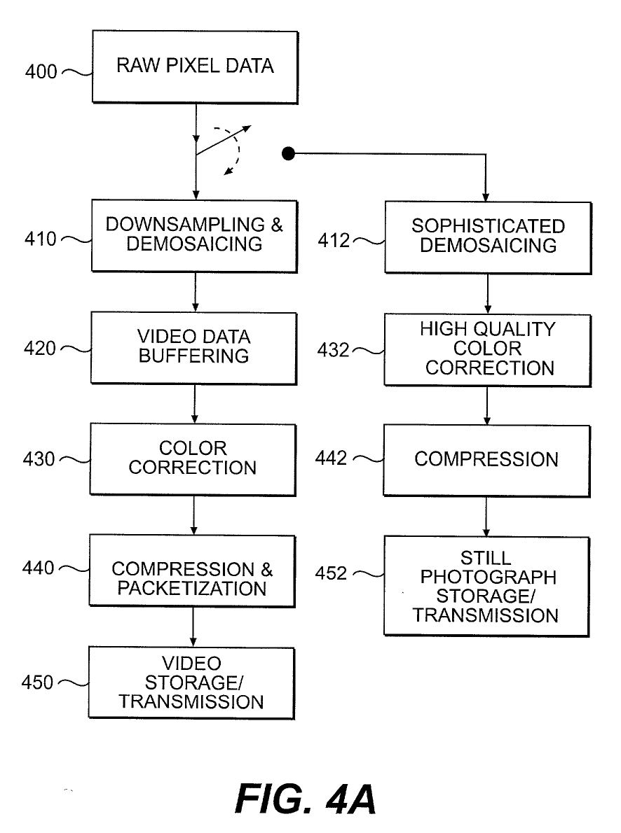

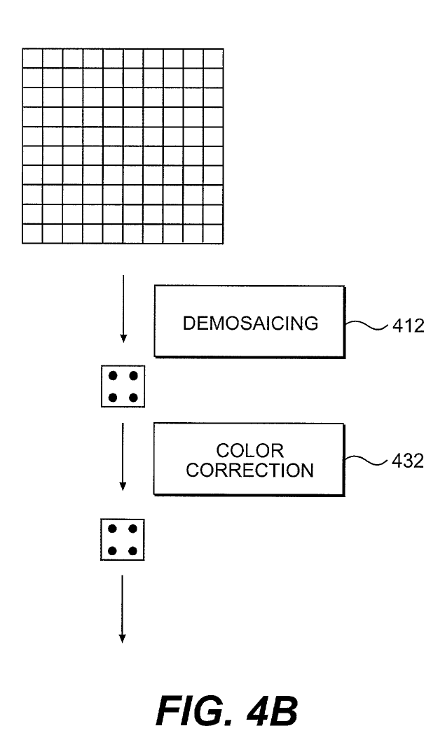

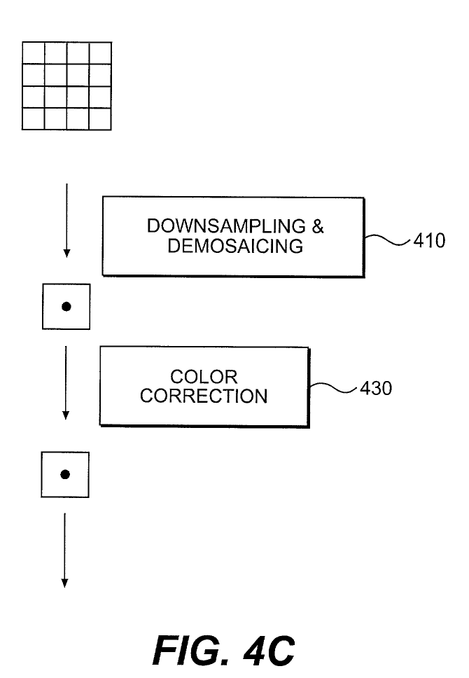

FIGS. 4A-4C are flow charts describing in general operation of the exemplary joint video and still image pipeline. Referring to FIG. 4A, operation of the video pipeline 220, shown on the left, typically results in continuous processing of video frames 120. Operation of the high resolution still image pipeline 210, shown on the right, typically results in processing a high resolution still image frame 110 every time the user wants to acquire a high resolution photograph 110.

After raw pixel video data of video frames 120 are acquired, for example, at 1024×1008 and 30 fps (block 400), the video frames 120 may be downsampled and demosaiced in order to save memory space (block 410). Then, the frame buffer 330 may buffer the video frames 120 while the high resolution still image frame 110 is being acquired, processed, stored, and/or transmitted (block 420). Alternatively, demosaicing may be performed after the video frames 120 are buffered. Thereafter, the video pipeline 220 may start emptying the frame buffer 330 as fast as possible, and performing color correction, compression, storage and/or transmission (blocks 430, 440, 450). Once the frame buffer 330 is emptied, another high resolution still image frame 110 may be acquired.

For high resolution still image frames 110, sophisticated demosaicing may be performed (block 412), followed by high quality color correction (block 432). The high resolution still image frames 110 may optionally be compressed (block 442), and then stored and/or transmitted through similar communications channels 260 (block 452).

FIG. 4B illustrates in detail the operation of the high resolution still image pipeline 210. The sophisticated demosaicing process (block 412) utilizes a high quality demosaicing algorithm that generates a high quality color image from the originally mosaiced image acquired by the image sensor 240. The demosaicing process is a time consuming filtering operation, which may gamma-correct the input if the image sensor 240 has not done so, resulting in excellent color image quality with almost no demosaicing artifacts. For example, demosaicing for high resolution still image frames 110 may filter the original image with a 10×10 linear filter. The algorithm takes into account the lens used for acquisition, as well as the spectral sensitivity of each of the color filters on the mosaic.

Once the high resolution still image frame 110 is demosaiced, the high resolution still image frame 110 may be color corrected depending on the illumination present at the time of the capture (block 432). Complex transformation matrixes may be involved to restore accurate color to the high resolution still image frames 110, in order to generate an excellent photograph. The color correction algorithms, may be similar to the algorithm used in the HP-PHOTOSMART 618®.

FIG. 4C illustrates in detail the operation of the video pipeline 220. A high quality video pipeline 220 may be very demanding in terms of computation. Because the video processing needs to be achieved at, for example, 30 fps, downsampling may be fast. In addition, lower resolution video frames 120 (for example, 640×480 pixels) demands much less quality demosaicing (block 410), because the human visual system may not notice certain artifacts at high video frame rates. For example, demosaicing for video frames 120 may filter the original image with a 4×4 linear filter. Similarly, color correction may be simpler because high quality is not needed on the video side (block 430).

When a user acquires high resolution still image frames 110 in burst mode, the digital video camera system 200 downsamples the video frames 120 into reduced size (downsampled) video frames. For example, the size of video frames may be downsampled from 640×480 pixels to 320×240 pixels. With lower quality video processing, the joint video and still image pipeline can spend more time processing the high resolution still image frames 110. Therefore, the video camera system 200 leverages between the video pipeline 220 and the high resolution still image pipeline 210 to reduce the computational burden, so that the burst mode high resolution still image frames 110 can be processed in real time with high priority, concurrently with the reduced size video frame processing.

After the high resolution still image frames 110 are demosaiced, color corrected, and compressed (with or without loss), the high resolution still image frames 110 may be used to reset MPEG encoding process as intraframes (I-frames). I-frames are frames not compressed depending on previous or future frames, i.e., stand alone compressed frames. Accordingly, all compression algorithms need to start with an I-frame, and all other frames may be compressed based on the I-frame.

The reduced size (downsampled) video frames 120 can be stored with near lossless compression or no compression at all, in order to recover as good a quality as possible. Finally the reduced size video frames 120 are upsampled to the original video size (for example, 640×480 pixels) using, for example, motion estimation. Information from the high resolution still image frames 110 may be used to recover the loss in quality of the video frames 120. Since many high resolution still image frames 110 are taken in burst mode, video frame quality can be improved through motion compensation and motion estimation technology, using information from the high resolution still image frames 110.

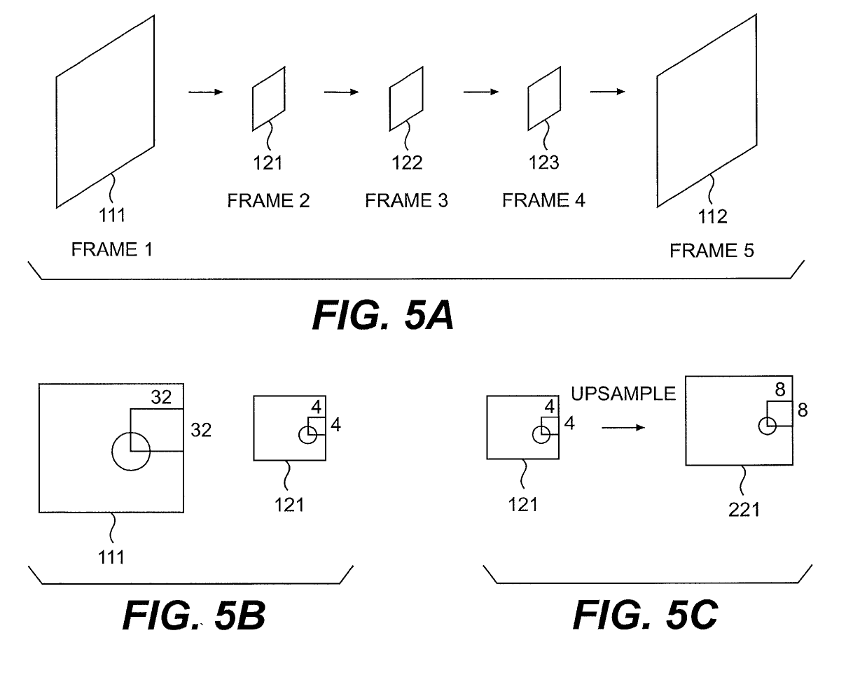

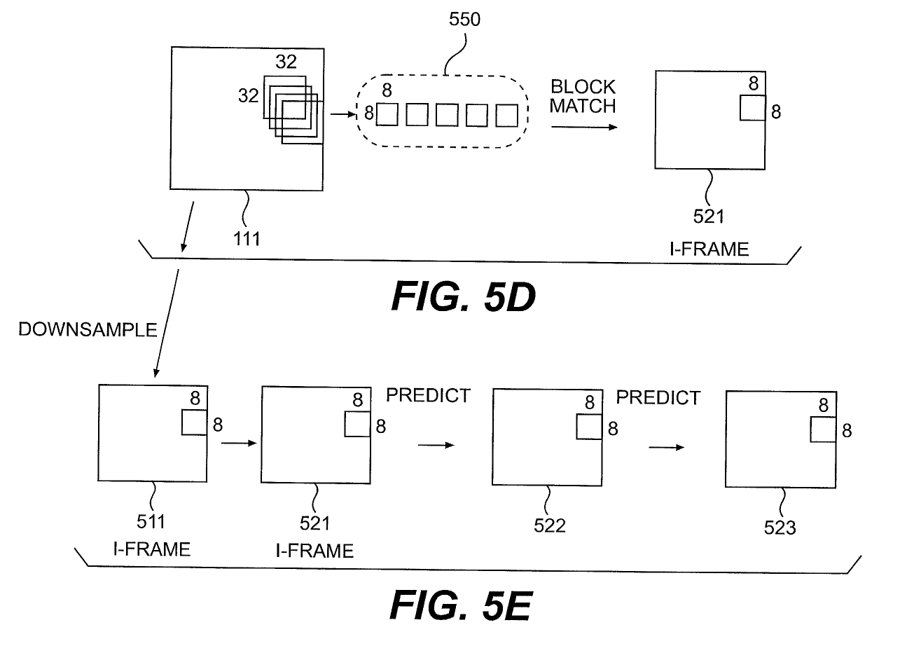

Motion estimation is described, for example, in “Image and Video Compression Standards” by Bhaskaran and Konstantinides, chapters 4.4-4.7, which is incorporated herein by reference. In motion estimation, a block of image is typically compared with a previous image frame to detect changes, then matched into the previous frame. For example, if a person moves her head and mouth with the background image unchanged, the background does not need to be compressed every time a new image is acquired. A motion detection system detects that the background is not moving, and copies the background from the previous frame. Motion estimation technology estimates changes in image frames and predicts future frames based on the changes. If, for example, one high resolution still image frame 110 is taken every eight video frames 120, the high resolution still image frame 110 can be downsampled and matched into other video frames 120 to compensate the loss in quality of the video frames 120 (described in detail with respect to FIGS. 5A-5C).

Within the video camera system 200, the reduced size video frames 120 may be kept in a nonstandard proprietary format. The video transcoding agent 270, which typically runs on the video camera system 200, transcodes the proprietary loss-less (or near loss-less) compressed video frames 120 into a sta 2. Alternatively, the video transcoding agent 270 may run on a docking station or on the host personal computer (PC).

For example, high resolution still image frames 110 are typically 2 mega (M) pixel in size, whereas the size of a video frame is typically 640×480=307,200 pixels. If the video frames 120 are acquired at 30 fps, the video pixel size is 30×307,200 pixels per second (pps). Therefore, the size of one high resolution still image is approximately 6.41 times the size of a video frame (2,000,000/307,200=6.41). Processing rate per pixel typically needs to be maintained approximately constant with and without burst mode, given maximum processing power of the pipelines.

In the following exemplary equations (for illustration purposes only), VS stands for video frame size; SS stands for still image size, which equals 6.41×VS; RF stands for reduction factor, which is the number of times the size of video frames 120 needs to be reduced in order to take a high resolution still image frame 110 simultaneously; and RS stands for reduced size, which equals VS/RF. The following equations calculates N, which stands for the number of video frames 120 between two high resolution still image frames 110. In other words, one high resolution still image frame 110 can be acquired and processed simultaneously with N video frames 120 using the limited hardware processing power. The reduced quality of the video frames 120 can be compensated during upsampling using motion estimation and information from the high resolution still image frames 110.

N*VS=SS+(N−1)RS

N*VS=6.41*VS+(N−1)VS/RF

RF*N=6.41*RF+N−1

For example, if RF=4, N=8.21. Therefore, if video size is reduced by a factor of four, one high resolution still image frame 110 can be acquired every 8.21 video frames 120.

If, for example, RF=2 instead, N becomes 11.82. Therefore, if video size is reduced by a factor of two, one high resolution still image frame 110 can be acquired every 11.82 video frames. In other words, a user needs to wait longer to process one high resolution still image frame 110.

Finally, if RF=1, the entire video frames 120 may be stored without any compression, requiring extra processing power and occupying extra storage. Since no video size reduction occurs, no extra time is available to process the high resolution still image frames 110. Therefore, with limited hardware processing power, the video frames 120 and the burst mode high resolution still image frames 110 cannot be processed simultaneously.

Accordingly, as N increases, video quality worsens, but more burst mode still image frames 110 may be acquired per second. The total power of the hardware processing pipeline is split between a reduced size video pipeline 220 and the high resolution still image pipeline 210.

FIGS. 5A-5E illustrate an exemplary motion estimation technology used by the video camera system 200 of FIG. 2. Referring to FIG. 5A, one high resolution still image frame 110 is taken every four video frames 120. Frames #1 and #5, 111 and 112, respectively, are high resolution still image frames. Frames #2, #3, and #4, 121, 122, 123, respectively, are reduced size (downsampled) video frames. Referring to FIG. 5B, in this example, the high resolution still image frame 111 (frame #1) is shown with one or more 32×32 blocks, the reduced size video frame 121 (frame #2) is shown with one or more 4×4 blocks, and a regular size video frame (not shown) typically has 8×8 blocks.

Referring to FIG. 5C, the processors 360 upsample the 4×4 block in the reduced size video frame 121 (frame #2) into an 8×8 block in an upsampled video frame 221. The upsampled video frame 221 typically has the same frame size as the regular size video frame. Likewise, all of the 4×4 blocks in the reduced size video frame 121 are upsampled into 8×8 blocks. The upsampling method may be simple or sophisticated, using, for example, bilinear interpolation, bicubic interpolation, or resolution synthesis.

Referring to FIG. 5D, the high resolution still image frame 111 (frame #1) is downsampled into a downsampled still image frame 511 (shown in FIG. 5E), which becomes an I-frame. The downsampled still image frame 511 typically has the same frame size as the upsampled video frame 221. Next, all of the 32×32 blocks in the high resolution still image frame 111 are downsampled into multiple 8×8 video frame size blocks, forming a block pool 550. All possible 32×32 blocks are considered in order to maximize quality. Then, all of the 8×8 blocks in the block pool 550 are compared with the 8×8 block in the upsampled video frame 221 until a best match block is found, using various motion estimation algorithms. Finally, the selected best match 8×8 block in the block pool 550 is copied into the corresponding position in the upsampled video frame 221. Similarly process needs to be performed for all of the 8×8 blocks in upsampled video frame 221, generating a new I-frame 521 for frame #2.

Referring to FIG. 5E, frames #3 and #4 can be predicted from frame #2 in order to increase compression ratio. For example, the processors 360 encode motion vectors of frame #2 (with video resolution of 640×480 pixels) in frame #3, which is upsampled from 4×4 block size to 8×8 block, generating frame 522. Error is encoded if necessary. Frame #4 523 can be generated in a similar fashion. In this example, two predicted (P) frames 522, 523 follow two I-frames 511, 521.

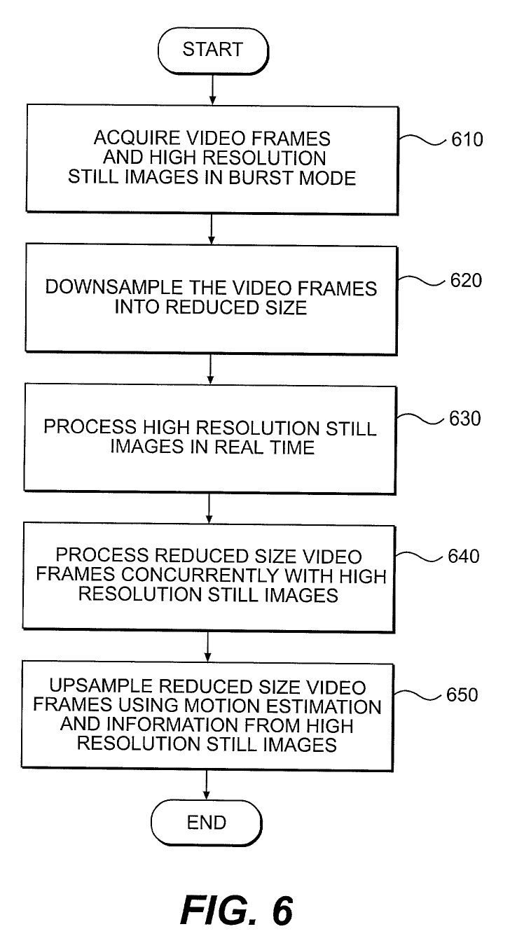

FIG. 6 is a flow chart illustrating the method for concurrently processing digital video frames and high resolution still image frames in burst mode. The video camera system 200 acquires video frames 120 and high resolution still image frames 110 in burst mode (block 610). The processors 360 then downsample the video frames 120 into reduced size video frames so that the single processing pipeline can allot more time to process the high resolution still image frames 110 (block 620). Next, the processors 360 process the high resolution still image frames 110 in real time (block 630), concurrently with the reduced size video frames (block 640). If extra processing power is available, the processors 360 upsample the reduced size video frames into regular size video frames using motion estimation technology and information from the high resolution still image frames acquired in burst mode (block 650). Alternatively, the upsampling and encoding process may be achieved during transmission/download time with the video transcoding agent 270. In other words, if the video frames are not fully encoded due to lack of memory space or processing power, the video frames can be encoded fully at download time by the video transcoding agent 270.

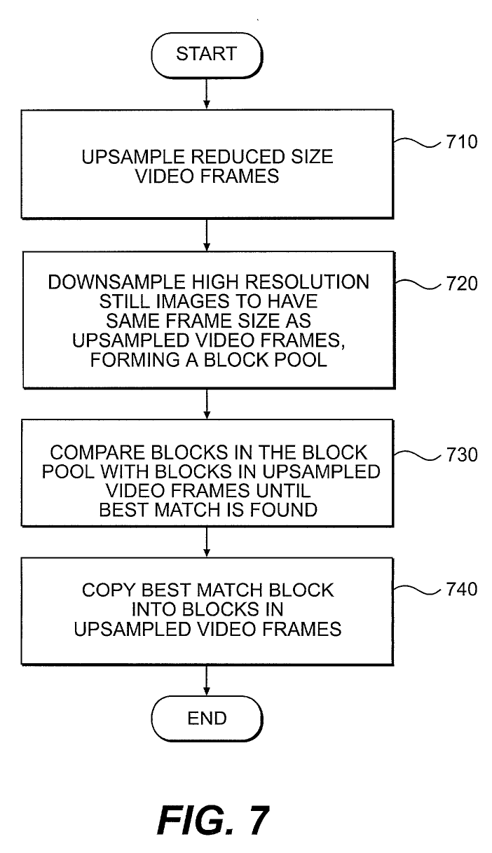

FIG. 7 is a flow chart illustrating the motion estimation technology used by the video camera system 200. First, the processors 360 upsample the reduced size video frame 121, so that the frame sizes of the upsampled video frame 221 are the same as the regular size video frames originally acquired by the image sensor 240 (block 710). Next, the processors 360 downsample the high resolution still image frame 111 into a downsampled still image frame 511, which has the same frame size as the upsampled video frame 221. All blocks in the high resolution still image frame 111 are downsampled into multiple video frame size blocks, forming a block pool 550 (block 720). Then, for each block in the upsampled video frame 221, the processors 360 compare all of the blocks in the block pool 550 with the corresponding block in the upsampled video frame 221, until a best match block is found (block 730). Finally, the best match block in the block pool 550 is copied into the corresponding block in the upsampled video frame 221, gradually generating a new I-frame 521 after similar process is performed for all of the blocks in the upsampled video frame 221 (block 740).

While the method and apparatus for concurrently processing digital video frames and high resolution still images in burst mode have been described in connection with an exemplary embodiment, those skilled in the art will understand that many modifications in light of these teachings are possible, and this application is intended to cover any variations thereof.

What is claimed is:

1. A method for concurrently processing digital video frames and high resolution still images in burst mode, comprising:
acquiring regular size video frames and high resolution still image frames in burst mode from one or more image sensors;
downsampling the regular size video frames into reduced size video frames, wherein the reduced size frames have frame sizes smaller than the regular size video frames;
processing the high resolution still image frames acquired during the burst mode using a high resolution still image pipeline; and
processing the reduced size video frames using a video pipeline, wherein the high resolution still image frames are processed concurrently with the reduced size video frames.

2. The method of claim 1, further comprising upsampling the reduced size video frames using motion estimation and information from the high resolution still image frames.

3. The method of claim 2, further comprising downsampling the high resolution still image frames, wherein the downsampled still image frames have same frame sizes as the upsampled video frames, and wherein blocks in the downsampled still image frames form a block pool.

4. The method of claim 3, further comprising:
comparing blocks in the block pool with corresponding blocks in the upsampled video frames until a best match block is found; and
copying the best match block into the corresponding blocks in the upsampled video frames.

5. The method of claim 1, wherein the processing the reduced size video frames step includes encoding the reduced size video frames into a standard format by a video transcoding agent.

6. The method of claim 1, wherein the processing the high resolution still image frames step includes processing the high resolution still image frames in real time.

7. The method of claim 1, wherein the processing the high resolution still image frames step comprises:
downsampling and demosaicing the high resolution still image frames using complex demosaicing algorithms; and
color correcting the high resolution still image frames using complex color correction algorithms.

8. The method of claim 1, further comprising compressing the reduced size video frames and the high resolution still image frames.

9. A joint video and still image pipeline for a video camera system, comprising:
one or more image sensors capable of concurrently acquiring regular size video frames and high resolution still image frames in burst mode, wherein the regular size video frames are downsampled into reduced size video frames;
a sensor controller capable of storing the regular size video frames and the high resolution still image frames acquired during the burst mode into a memory; and
one or more processors capable of concurrently processing the reduced size video frames and the high resolution still image frames acquired during the burst mode, wherein the reduced size video frames are processed using a video pipeline, and the high resolution still image frames are processed using a high resolution still image pipeline, and wherein the high resolution still image frames are processed concurrently with the reduced size video frames.

10. The joint video and still image pipeline of claim 9, wherein the reduced size video frames are upsampled using motion estimation and information from the high resolution still image frames.

11. The joint video and still image pipeline of claim 10, wherein the high resolution still image frames are downsampled to have the same frame sizes as the upsampled video frames, and wherein blocks in the downsampled still image frames form a block pool.

12. The joint video and still image pipeline of claim 11, wherein blocks in the block pool are compared with corresponding blocks in the upsampled video frames until a best match block is found, and wherein the best match block is copied into the corresponding blocks in the upsampled video frames.

13. The joint video and still image pipeline of claim 9, further comprising a video transcoding agent capable of encoding the reduced size video frames into a standard format.

14. The joint video and still image pipeline of claim 9, wherein the high resolution still image frames are processed in real time.

15. The joint video and still image pipeline of claim 9, wherein the processors are selected from a microprocessor, an application specific integrated circuit (ASIC), and a digital signal processor.

16. The joint video and still image pipeline of claim 9, wherein the processors downsample, demosaic, and color correct the high resolution still image frames using complex algorithms.

17. A computer readable medium providing instructions for concurrently processing digital video frames and high resolution still images in burst mode, the instructions comprising:
acquiring regular size video frames and high resolution still image frames in burst mode from one or more image sensors;
downsampling the regular size video frames into reduced size video frames, wherein the reduced size frames have frame sizes smaller than the regular size video frames;
processing the high resolution still image frames acquired during the burst mode using a high resolution still image pipeline; and
processing the reduced size video frames using a video pipeline, wherein the high resolution still image frames are processed concurrently with the reduced size video frames.

18. The computer readable medium of claim 17, further comprising instructions for upsampling the reduced size video frames using motion estimation and information from the high resolution still image frames.

19. The computer readable medium of claim 18, further comprising instructions for downsampling the high resolution still image frames, wherein the downsampled still image frames have same frame sizes as the upsampled video frames, and wherein blocks in the downsampled still image frames form a block pool.

20. The computer readable medium of claim 19, further comprising:
comparing blocks in the block pool with corresponding blocks in the upsampled video frames until a best match block is found; and
copying the best match block into the corresponding blocks in the upsampled video frames.
